(19) United States
(12) Patent Application Publication
(10) Pub. No.: US 2025/0233489 A1
(43) Pub. Date: Jul. 17, 2025

(54) ROTOR ARRANGEMENT FOR A SEPARATELY EXCITED SYNCHRONOUS MACHINE

(71) Applicant: ZF FRIEDRICHSHAFEN AG, Friedrichshafen (DE)

(72) Inventors: Tobias DIECKHOFF, Würzburg (DE); Manuel RAIMANN, Salem (DE); Robin MICHELBERGER, Schweinfurt (DE); Rene BUDACH, Bad Kissingen (DE); Philipp KRAFT, Würzburg (DE)

(21) Appl. No.: 18/838,748

(22) PCT Filed: Feb. 14, 2023
(86) PCT No.: PCT/EP2023/053654

§ 371 Date: Aug. 15, 2024

(30) Foreign Application Priority Data
Feb. 16, 2022 (DE) 10 2022 201 589.4

(51) Int. Cl. H02K 11/042; H02K 7/00; H02K 9/19

(52) U.S. Cl. CPC H02K 11/042; H02K 7/003; H02K 9/19

(57) ABSTRACT

A rotor arrangement for a separately excited synchronous that includes a rotor shaft for at least one exciter winding, which rotor shaft is formed as a hollow shaft, and a transformer arranged inside of the rotor shaft for contactless transfer to the exciter winding of a current which is needed for generating a rotor field.

### CROSS REFERENCE TO RELATED APPLICATIONS

This is a U.S. national stage of Application No. PCT/EP2023/053654 filed Feb. 14, 2023. Priority is claimed on German Application No. DE 10 2022 201 589.4 filed Feb. 16, 2022 the content of which is incorporated herein by reference.

### BACKGROUND OF THE INVENTION

### 1. Field of the Invention

The present disclosure is directed to electric machines generally and to rotor arrangements for separately excited synchronous machines particularly.

### 2. Description of the Related Art

Separately excited synchronous machines as drives for vehicles, such as passenger cars, for example, utilize conductive transmission devices for transferring a current needed for generating a rotor field from the stationary system to a rotating system. These transmission devices may be constructed, for example, as carbon brush arrangements or slip ring arrangements. Further, brushless transmission devices are also known that are based in particular on inductive transfer. These are essentially transformers whose primary side and secondary side are separated from one another by an air gap and constructed to be rotatable relative to one another. Further, a rectifier circuit is located on the secondary side in order to convert the AC current needed for transmission into a DC current needed for generating a magnetic field.

Compared to a permanently excited synchronous machine, a separately excited synchronous machine additionally requires, inter alia-instead of permanent magnets in the rotor—an exciter winding at the rotor and a transmission device for the current from the stationary system to the rotor. One challenge is to configure and arrange the transmission device in particular as far as possible in such a way that the installation length of the electric machine is not increased or, if so, as little as possible. A further challenge consists in that in solutions known heretofore it is usually the installation space below the winding heads of the stator winding that is used for arranging the transmitter or the rectifier electronics, where high temperatures prevail proceeding from the winding heads on the one hand and cooling is difficult on the other hand. Additional seals and enclosures are to be avoided for reasons of efficiency and cost.

### SUMMARY OF THE INVENTION

Accordingly, there is a need for contactless transmission systems with compact installation length and excellent cooling possibilities for separately excited synchronous machines.

This need is met by rotor arrangements and separately excited synchronous machines.

A rotor arrangement for a separately excited synchronous machine is suggested. The rotor arrangement comprises a rotor shaft for at least one exciter winding, which rotor shaft is formed as a hollow shaft. The rotor arrangement further comprises a transformer arranged inside of the rotor shaft (hollow shaft) for contactless (inductive) transfer to the exciter winding of a current which is needed for generating a rotor field. The suggested solution accordingly provides for arranging an inductive energy transmission device (transformer) inside of the hollow shaft of the electric machine. An appreciable reduction of installation space can be achieved in this way.

According to one aspect of the present invention, the transformer can have inside of the rotor shaft a primary side, which is fixed with respect to the stator and a secondary side, which is rotatable with respect to the stator around a rotational axis and coupled with the rotor shaft so as to be fixed with respect to rotation relative to it. Accordingly, the primary side of the transformer arranged inside of the rotor shaft can be coupled with the stationary system of the separately excited synchronous machine, while the secondary side of the transformer is coupled with the rotatable rotor shaft.

According to one aspect of the present invention, the rotor arrangement can further have a carrier that is fixed with respect to the stator and which projects axially into a hollow space of the rotor shaft and is mechanically coupled with the primary side of the transformer. The carrier for the primary side of the transformer can be lance-shaped, for example, and carries or supports the primary side of the transformer at its outer circumference.

According to one aspect of the present invention, the carrier for the primary side of the transformer can be formed hollow in order to introduce a coolant (for example, oil) into the rotor shaft through a hollow space of the carrier. According to one aspect, the carrier can be formed as a hollow (oil) lance projecting into the rotor shaft. In this way, the cooling of the component parts can be improved in that oil flows completely around or through these component parts through the hollow shaft. This can be advantageous compared, for instance, to an arrangement outside of the shaft in the region of the winding heads, since only an oil mist cooling is possible in this area and additional heat is introduced by the winding heads.

According to one aspect of the present invention, the rotor shaft can be formed closed at least at one end in order to deflect the coolant flowing through the carrier into the rotor shaft at the closed end. The carrier, which is formed hollow, can project into the rotor shaft, for example, in axial direction until just up to the closed end of the rotor shaft. The coolant can flow out at the end of the carrier in direction of the closed end of the rotor shaft and be deflected there in the opposite direction (away from the closed end of the rotor shaft). An efficient coolant flow through the rotor shaft and through the components located therein (for example, transformer) can be achieved in this way.

According to one aspect of the present invention, the rotor shaft can have radial bore holes in its outer surface (or outer lateral surface) in order to guide the coolant radially out of the rotor shaft before and/or after the coolant flows through the rotor shaft and the transformer arranged therein. The coolant can then be cooled down again outside of the rotor shaft and guided back once again to a coolant circulation.

According to one aspect of the present invention, the transformer can comprise a primary-side ferrite core, which is fixed with respect to the stator and in which a primary-side winding of the transformer is inserted. Further, the transformer can comprise a secondary-side ferrite core, which is rotatable relative to the primary-side ferrite core and coupled with the rotor shaft so as to be fixed with respect to rotation relative to it, a secondary-side winding of the transformer being inserted in this secondary-side ferrite core. Of course, soft-magnetic materials other than ferrite that increase inductance are also contemplated for coil cores.

According to one aspect of the present invention, the rotor arrangement can further have a rectifier which is arranged inside of the rotor shaft and is electrically coupled between the secondary side of the transformer and the exciter winding. By the rectifier, the AC current required for the inductive transfer can be converted into DC current required for generating the magnetic field. Coolant can also advantageously flow through and around the rectifier inside of the rotor shaft.

According to one aspect of the present invention, the rotor arrangement can further have an inverter that is electrically coupled with the primary side of the transformer. AC current required for the inductive transfer can be generated from DC current by the inverter. The inverter can be arranged inside of or outside of the rotor shaft.

According to one aspect of the present invention, the exciter winding (rotor winding) can extend axially along the rotor shaft from a starting region to an end region. The transformer (and possibly also the rectifier) can be arranged axially between the starting region and the end region of the exciter winding inside of the rotor shaft. Accordingly, axial installation space can advantageously be economized.

Further, a separately excited synchronous machine is proposed that comprises a stator and a rotor with at least one exciter winding, the rotor being rotatably supported relative to the stator by a hollow shaft. A transformer for contactless transfer of a current required for rotor field generation to the exciter winding is arranged inside of the hollow shaft.

According to one aspect of the present invention, the separately excited synchronous machine can further comprise a coolant lance fixed with respect to the stator and that projects axially into the hollow shaft. The coolant lance is configured to support a primary side of the transformer, which primary side is fixed with respect to the stator, and to introduce coolant (for example, oil) through a hollow space of the coolant lance into the hollow shaft.

Further, a motor vehicle with a separately excited synchronous machine having a rotor arrangement described herein is also suggested.

### BRIEF DESCRIPTION OF THE DRAWINGS

Individual aspects of the present invention will be described by way of example in the following referring to the drawings. The drawings show:

FIG. 1 is a rotor arrangement for a separately excited synchronous machine;

FIG. 2 is a construction of a clamping connection of an inner ferrite core;

FIG. 3 is a cross-section through a rectifier arrangement inside of a rotor shaft;

FIG. 4 is a coolant oil flow through the rotor arrangement; and

FIG. 5 is an expansion of the suggested cooling concept.

### DETAILED DESCRIPTION OF THE PRESENTLY PREFERRED EMBODIMENTS

A synchronous machine is a rotating electric machine in which the rotor runs synchronous with a rotational field of the stator. Synchronous machines are often constructed as three-phase machines, i.e., as three-phase synchronous machines. The synchronous machine is so called because of the operating characteristic whereby its rotor circulates exactly synchronous with the rotational field determined by a line frequency.

A constant magnetic field is generated in the rotor. This is effected either by a permanent magnet (permanently excited) or by an electromagnetic separate excitation (separately excited). Depending on the type of construction of the synchronous machine, the rotor can be constructed as salient pole rotor or smooth-core rotor. In contrast, a magnetic rotational field is generated in the stator in that, for example, this rotational field is generated by three-phase AC. Three inductances which are arranged so as to be offset by 120° can be used for this purpose. Of course, more phases or fewer phases can also be used.

Every synchronous machine can in principle be operated as an electric motor and electric generator. When the synchronous machine is operated as a generator, the rotor is mechanically driven externally. Therefore, if it is a separately excited rotor, it must be excited correspondingly. The magnetic field of the rotor periodically induces a voltage in the stator windings. This voltage is referred to as synchronous generated voltage. When operated as a motor, a three-phase AC voltage is applied externally to the synchronous machine, for example. The magnetic rotational field of the stator which is generated in this way sets the rotor in motion. The machine can accordingly drive an external mechanical load, such as a motor vehicle.

One aspect of the present invention is directed to rotor arrangements for separately excited synchronous machines which can be used, for example, in (semi-) electrically operated motor vehicles.

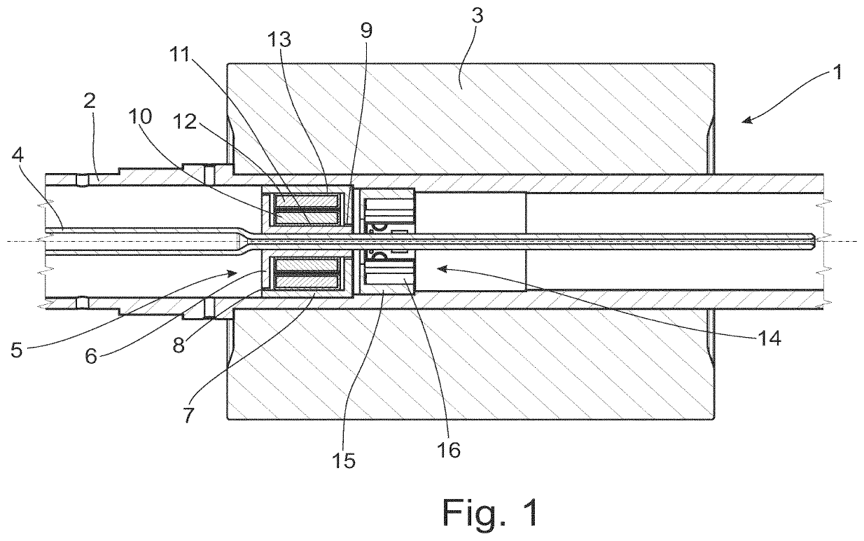

FIG. 1 shows a rotor arrangement 1 for a separately excited synchronous machine according to one aspect of the present invention.

The exemplary rotor arrangement 1 comprises a rotor shaft 2 formed as a hollow shaft. The rotor shaft 2 can carry at least one exciter winding or rotor winding (not shown) at its outer circumference by a rotor lamination stack 3. An inductive transmission device 5 (transformer) for contactless (inductive) transfer of a current required for generating a rotor field to the at least one exciter winding is arranged inside the hollow rotor shaft 2. Installation space can advantageously be economized through the arrangement of the inductive transmission device 5 inside of the rotor shaft 2.

The rotor arrangement 1 shown in FIG. 1 is substantially formed by the hollow rotor shaft 2, the rotor lamination stack 3 being arranged at the outer circumference thereof. One or more rotor exciter windings inserted in the rotor lamination stack 3 are not shown in FIG. 1, nor are the stationary stator windings of the separately excited synchronous machine which are arranged radially outside of the rotor arrangement 1 or rotor lamination stack 3, respectively.

The rotor lamination stack 3 arranged at the outer circumference of the rotor shaft 2 extends axially from a starting region (left-hand side) to an end region (right-hand side) along the rotor shaft 2. A shaft shoulder can be provided at the outer circumference of the rotor shaft 2 in the starting region (left-hand side) of the rotor lamination stack 3 as an axial stop for the rotor lamination stack 3. In the depicted embodiment example, the transformer 5 is arranged axially between the starting region and the end region of the rotor lamination stack 3 inside of the rotor shaft 2. Accordingly, no additional axial installation space is required for the transformer 5. However, it will be appreciated that the transformer 5 could also be arranged in principle at other axial positions inside of the rotor shaft 2, such as axially (on the left-hand or right-hand side) outwardly of the rotor lamination stack 3 or axially so as to only partially overlap with the rotor lamination stack 3.

Located in the interior of the rotor shaft 2 in the depicted embodiment example is an oil lance 4 fixed with respect to the stator and which projects in axial direction (toward the right-hand side) into the hollow space of the rotor shaft 2 proceeding from a first axial end (left-hand side) of the rotor shaft 2 and which can introduce, e.g., cooling oil into the rotor shaft 2. Coolant other than oil (for example, air, water or another liquid coolant) is also contemplated. Oil has the advantage that it can simultaneously also act as lubricant. Toward the first axial end (left-hand side) of the rotor shaft 2, a first (inner) diameter of the oil lance 4 is formed in the present instance to be larger than a second (inner) diameter of the oil lance 4 toward an opposite second axial end (right-hand side) of the rotor shaft 2. A pressure of the cooling oil flowing into the rotor shaft 2 can be increased through a constriction from the first (inner) diameter to the second (inner) diameter of the oil lance 4. This can have advantageous results for a flow rate of the oil and, therefore, the cooling effect thereof.

Further, the oil lance 4 in the depicted embodiment example also serves as carrier for a primary side of the transformer 5, which primary side is fixed with respect to the stator. In the depicted example, the transformer 5 located in the interior of the rotor shaft 2 has a primary-side ferrite core 6 which is fixed with respect to the stator and in which a primary-side winding 10 of the transformer 5 is inserted. This can also be constructed, for example, as ribbon stranded wire winding or HF (high-frequency) stranded wire winding and can also be surrounded by a primary-side winding carrier 11. The primary-side winding carrier 11 can serve to maintain the shape of the primary-side winding 10 during assembly and to provide an enhanced electrical isolation of the winding stack relative to the primary-side ferrite core 6, and therefore, the stator (not shown), for safety reasons. The primary-side ferrite core 6 is mechanically fixedly connected to the oil lance 4 and is therefore fixed with respect to the stator. The primary-side ferrite core 6 is rotationally symmetrical and attached to an outer circumference of the oil lance 4. Further, the primary-side ferrite core 6 can comprise an axial portion and a portion facing radially outward. In the embodiment example shown in FIG. 1, the axial portion of the primary-side ferrite core 6 is fixedly coupled with the outer circumference of the oil lance 4.

The second portion of the transformer 5 comprises a secondary-side ferrite core 7, which is coupled with the rotor shaft 2 at the inner circumference thereof so as to be fixed with respect to rotation relative to it and so as to be rotatable relative to the primary-side ferrite core 6, a secondary-side winding 12 of the transformer 5 being inserted therein. This can also be constructed as a ribbon stranded wire winding or HF stranded wire winding and can be surrounded by a secondary-side winding carrier 13. The secondary-side winding carrier 13 can serve to maintain the shape of the secondary-side winding 12 during assembly and to provide an enhanced electrical isolation of the winding stack relative to the secondary-side ferrite core 7, and therefore the rotor, for safety reasons. The secondary-side ferrite core 7 is mechanically connected to the rotor shaft 2 and is therefore fixed with respect to the rotor. The secondary-side ferrite core 7 is rotationally symmetrical and attached to an inner circumference of the rotor shaft 2. Further, the secondary-side ferrite core 7 can comprise an axial portion and a portion facing radially inward. In the embodiment example shown in FIG. 1, the axial portion of the secondary-side ferrite core 7 is coupled with the inner circumference of the rotor shaft 2 so as to be fixed with respect to rotation relative to it. The windings 10 and 12 are framed by the axial and radial portions of the ferrite cores 6 and 7.

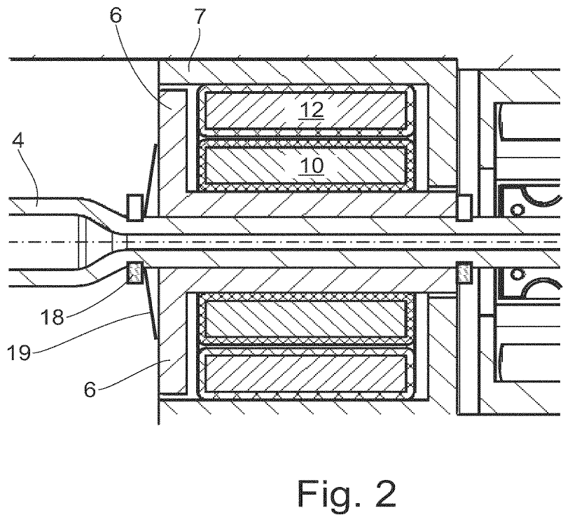

Because ferrite is brittle, tensile stresses should be introduced as little as possible during the assembly of the rotor arrangement 1. The secondary-side ferrite core 7 inserted into the rotor shaft 2 can be pressed into the rotor shaft 2, for example, since compressive stresses occur in the material in this way. It can also be optimally supported under centrifugal force outwardly by the rotor shaft 2. However, the primary-side ferrite core 6 should not be pressed (shrunk) onto the oil lance 4 because it could crack as a result of tensile stresses. In this case, either an adhesive bond or a mechanical connection in which the primary-side ferrite core 6 is axially clamped or held via a positive engagement may be advantageous. FIG. 2 shows a possible construction of a clamping connection of the inner primary-side ferrite core 6. In this case, two snap rings 18 on axially opposing sides of the primary-side ferrite core 6 serve as axial abutment against the oil lance 4. A plate spring 19 can ensure a needed contact pressing force between one of the snap rings 18 (for example, the snap ring 18 facing the constriction of the oil lance 4) and the primary-side ferrite core 6.

The primary side or primary-side winding 10 of the transformer 5 can be electrically connected to an electric inverter (not shown) which provides the AC current needed for the functioning of the transformer 5. The secondary side or secondary-side winding 12 can be electrically connected to a rectifier arrangement 14. This is necessary in order to convert the AC current into a DC current which is needed for building up the rotor exciter field.

In the depicted embodiment example, the rectifier arrangement 14 coupled between the secondary side of the transformer 5 and the exciter winding is also arranged in the interior of the hollow rotor shaft 2. In the depicted embodiment example, the rectifier arrangement 14 is also arranged axially between the starting region and the end region of the rotor lamination stack 3 inside of the rotor shaft 2. Accordingly, there is no need for additional axial installation space for the rectifier arrangement 14. However, it will be appreciated that the rectifier arrangement 14 could in principle also be arranged at other axial positions inside of the rotor shaft 2, such as axially (on the left-hand side or right-hand side) outwardly of the rotor lamination stack 3 or axially only partially overlapping with the rotor lamination stack 3.

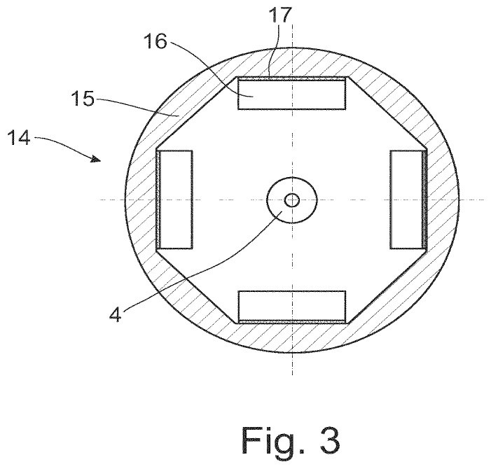

FIG. 3 shows a schematic cross-section through the rectifier arrangement 14.

The rectifier arrangement 14 substantially comprises a rectifier housing 15 which is inserted into the rotor shaft 2 and can be connected with the latter mechanically (so as to be fixed with respect to rotation relative to it) and electronic components, e.g., rectifier diodes 16. An outer circumference of the rectifier housing 15 is adapted to the inner circumference of the rotor shaft 2. An inner circumference of the rectifier housing 15 is formed as a polygon (in this case, an octagon) in the present embodiment example so that the rectifier diodes 16 can be arranged on tangential surfaces in the interior of the rectifier housing 15. The rectifier diodes 16 can be connected to the rectifier housing 15 via insulating pads 17 to be electrically insulating but so as to be as thermally conductive as possible. The rectifier housing 15 can preferably be produced from aluminum so that the heat given off by the rectifier diodes 16 can be well dissipated. By arranging the rectifier diodes 16 on tangential surfaces in the interior of the rectifier housing 15, the components can be optimally supported vis-à-vis centrifugal force. The rectifier circuit is electrically connected to the exciter winding of the rotor on the secondary side, although this is not shown.

The transformer 5 and rectifier arrangement 14 can heat up during operation of the synchronous machine, for which reason cooling with coolant (cooling oil) may be advantageous.

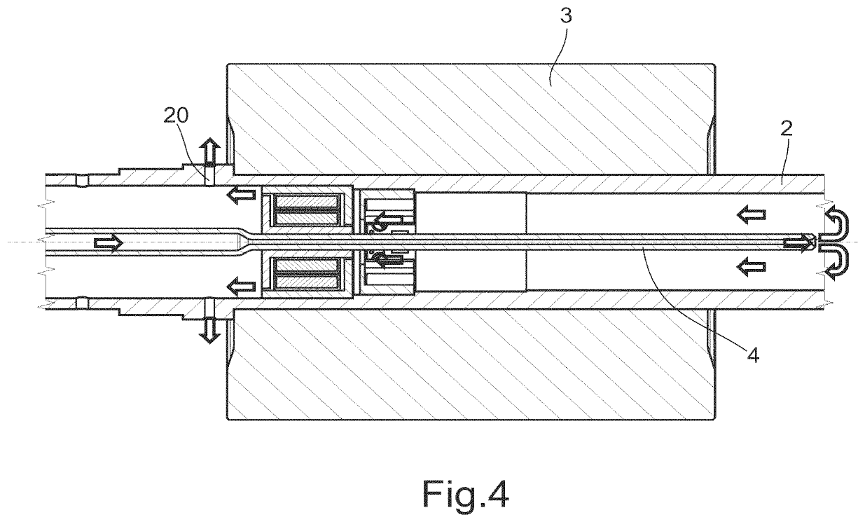

FIG. 4 shows an exemplary cooling oil flow through the rotor arrangement 1.

The arrows indicate the direction of flow of the oil initially through the oil lance 4 and, after exiting from the oil lance 4, through the rotor shaft 2 and the rectifier arrangement 14, wherein the rectifier diodes 16 can be optimally cooled in that oil flows around them, and, subsequently, through an (air) gap 8, 9 between the primary side and the secondary side of the transformer 5, wherein, in particular, the primary-side winding 10 and secondary-side winding 12 are also cooled, and then, for example, through radial bore holes 20 in the outer surface of the rotor shaft 2 outwardly in direction of the winding heads (not shown). The rotor shaft 2 can have radial bore holes 20 in its outer surface downstream of the transformer 5 viewed in flow direction of the cooling oil in order to guide the cooling oil out of the rotor shaft 2 again after the cooling oil flows through the rectifier 1 and the transformer 5.

With regard to a requisite cooling of thermally critical locations in the system as a whole, it may be useful not to direct the entire volume flow introduced via the oil lance 4 through the current transmitting device 5. To this end, bypasses can be produced (not shown) for the ferrite cores 6, 7 or the rectifier housing 15 for bypassing the transmission device 5 via slots or bore holes at the rotor shaft 2, for example. The rotor arrangement 1 can accordingly be formed to guide a first portion of the coolant introduced via the lance 4 through the transformer 5 in order to cool the latter and a second portion of the coolant past the transformer 5 for cooling other areas of the synchronous machine.

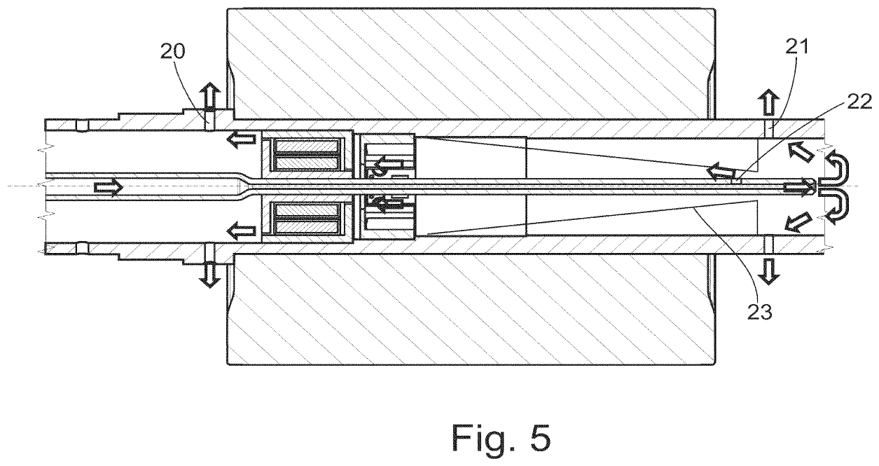

FIG. 5 shows a possible expansion of the cooling concept which has the aim of directing approximately equal quantities of oil outward from the rotor shaft 2 to the winding heads of the stator on both axial sides of the rotor lamination stack 3 through respective cooling oil bore holes 20 and 21. This can be achieved, for example, by providing a radial bore hole 22 in the outer surface of the oil lance 4 in the vicinity of an axial orifice at the end of the oil lance 4 in the rotor shaft 2. First radial bore holes 20 in the rotor shaft 2 can accordingly be provided at the axial starting region of the rotor lamination stack 3, and second radial bore holes 21 can be provided in the rotor shaft 2 at the axial end region of the rotor lamination stack 3. Both radial bore holes 20, 21 can be adapted to one another in such a way that approximately equal quantities of oil can exit therefrom in each instance. The rotor shaft 2 has radial bore holes 20 and 21, respectively, in its outer surface, i.e. at both axial ends of the rotor lamination stack 3, in order to guide the coolant out of the rotor shaft 2 before and also after coolant flows through the transformer 5.

Further, an oil guide element 23 can be provided in the interior of the rotor shaft 2. The oil guide element 23 can be configured and positioned in such a way that an oil flow exiting from the axial orifice at the end of the oil lance 4 is flung off onto a winding head through the radial bore hole 21 of the rotor shaft 2 in the end region of the rotor lamination stack 3 (right-hand side), while an oil flow exiting through a radial bore hole 22 at the end of the oil lance 4 is guided by centrifugal force in direction of the transformer 5 and rectifier arrangement 14 and is flung off behind the latter onto the other winding head through the radial bore hole 20 of the rotor shaft 2 in the starting region of the rotor lamination stack 3 (left-hand side). To this end, the oil guide element 23 can have a cone-shaped outer lateral surface which narrows in diameter from the rectifier arrangement 14 toward the end of the oil lance 4. The radial bore hole 22 at the end of the oil lance 4 can be arranged in the region of the tip of the cone inside of the cone of the oil guide element 23. The axial orifice at the end of the oil lance 4 can project axially from the tip of the cone of the oil guide element 23. The oil guide element 23 can accordingly be formed to guide a first portion of the coolant introduced via the lance 4 through the rectifier 14 and the transformer 5 for cooling the latter and to guide a second portion of the coolant past the transformer 5 (and rectifier 14) for cooling other areas (e.g., stator winding heads) of the synchronous machine.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A rotor arrangement for a separately excited synchronous machine, comprising:
a rotor shaft formed as a hollow shaft for at least one exciter winding; and
a transformer arranged inside the rotor shaft for contactless transfer to the at least one exciter winding of a current which is needed for generating a rotor field.

14. The rotor arrangement according to claim 13, wherein the transformer comprises:
a primary side which is fixed with respect to a stator; and
a secondary side which is rotatable with respect to the stator around a rotational axis and coupled with the rotor shaft so as to be fixed with respect to rotation relative to the rotor shaft.

15. The rotor arrangement according to claim 14, further comprising:
a carrier which is fixed with respect to the stator and which projects axially into a hollow space of the rotor shaft and is mechanically coupled with the primary side of the transformer.

16. The rotor arrangement according to claim 15, wherein the carrier is hollow and configured to introduce a coolant into the rotor shaft through a hollow space of the carrier.

17. The rotor arrangement according to claim 16, wherein the rotor shaft is closed at least at one end to deflect the coolant flowing through the carrier into the rotor shaft at the closed end.

18. The rotor arrangement according to claim 16, wherein the rotor shaft has radial bore holes in its outer surface to guide the coolant out of the rotor shaft before and/or after the coolant flows through the transformer arranged therein.

19. The rotor arrangement according to claim 13, wherein the transformer comprises:
a primary-side ferrite core which is fixed with respect to a stator and in which a primary-side winding of the transformer is inserted; and
a secondary-side ferrite core which is rotatable relative to the primary-side ferrite core, is coupled with the rotor shaft so as to be fixed with respect to rotation relative to the rotor shaft and in which a secondary-side winding of the transformer is inserted.

20. The rotor arrangement according to claim 19, further comprising a rectifier which is arranged inside the rotor shaft and is electrically coupled between the secondary side of the transformer and the at least one exciter winding.

21. The rotor arrangement according to claim 19, further comprising an inverter which is electrically coupled with the primary side of the transformer.

22. The rotor arrangement according to claim 13, wherein the at least one exciter winding extends axially along the rotor shaft from a starting region to an end region, and wherein the transformer is arranged axially between the starting region and the end region of the at least one exciter winding inside of the rotor shaft.

23. A separately excited synchronous machine, comprising:
a stator;
a rotor with at least one exciter winding, wherein the rotor is rotatably supported relative to the stator by a hollow shaft; and
a transformer for contactless transfer of a current required for rotor field generation to an exciter winding is arranged inside the hollow shaft.

24. The separately excited synchronous machine according to claim 23, further comprising:
a coolant lance which is fixed with respect to the stator and which projects axially into the hollow shaft to support a primary side of the transformer, which primary side is fixed with respect to the stator, and to introduce coolant through a hollow space of the coolant lance into the rotor shaft.
